(19) United States
(12) Patent Application Publication
(10) Pub. No.: US 2025/0241346 A1
(43) Pub. Date: Jul. 31, 2025

(54) (ORIGINAL SKEET'S BAR-B-QUE SAUCE OF OMAHA, NEBRASKA) BAR-B-QUE (BBQ) SAUCE RECIPE

(71) Applicant: Kevin Hawthorne, Omaha, NE (US)

(72) Inventor: Kevin Hawthorne, Omaha, NE (US)

(21) Appl. No.: 19/028,151

(22) Filed: Jan. 17, 2025

Related U.S. Application Data
(60) Provisional application No. 63/625,097, filed on Jan. 25, 2024.

(51) Int. Cl. A23L 23/00

(52) U.S. Cl. CPC A23L 23/00

(57) ABSTRACT

A BBQ sauce comprising approximately 36 ounces of tomato paste, 36 ounces of ketchup, 36 ounces of water, 4 ounces of vinegar, 2 ounces of cinnamon; and 8 ounces of brown sugar. The present invention is also directed at a method of making a BBQ sauce comprising the method comprising mixing the sauce ingredients at the listed ratios, heating the resulting mixture to a slow boil; and stirring the mixture for 15 to 20 minutes until well blended.

### CROSS-REFERENCE TO RELATED APPLICATION

This application claims the benefit of priority of U.S. provisional application No. 63/625,097, filed Jan. 25, 2024, the contents of which are herein incorporated by reference.

### BACKGROUND OF THE INVENTION

Bar-B-Que (BBQ) sauce is a flavorful condiment typically used in grilling and barbecuing to enhance the taste of meats like ribs, chicken, and burgers. It varies widely in flavor, texture, and ingredients, but generally features a balance of sweet, tangy, smoky, and sometimes spicy notes.

Key ingredients often include:

Tomato-based elements like ketchup or tomato paste for a rich, slightly sweet base.

Vinegar for acidity and tang, which also helps to tenderize meat.

Sugar or molasses for sweetness, contributing to the sauce's caramelized finish when cooked.

Spices and seasonings, such as garlic powder, onion powder, cayenne pepper, black pepper, paprika, and mustard, which add depth and complexity.

Liquid smoke or smoked ingredients that provide a smoky flavor, mimicking the effect of cooking over an open flame.

The present invention relates to a novel and useful BBQ sauce recipe. The recipe is based on a unique combination of tomato-based ingredients, sugars, seasoning, spices and liquids. The ratio of ingredients makes for the uniqueness of the sauce.

### SUMMARY OF THE INVENTION

In one aspect of the present invention, there is disclosed a BBQ sauce recipe that is based on a unique combination of tomato-based ingredients, sugars, seasoning, spices and liquids.

In another aspect of the present invention, the BBQ sauce of the present invention, (THE ORIGINAL SKEET'S BAR-B-QUE SAUCE OF OMAHA, NEBRASKA), comprises a unique combination of tomato paste, ketchup, water, vinegar, cinnamon and brown sugar. The ingredients should be mixed until well blended and then heated for 15-20 minutes.

These and other features, aspects and advantages of the present invention will become better understood with reference to the following drawings, description and claims.

### BRIEF DESCRIPTION OF THE DRAWINGS

FIG. 1 is a pie chart showing the various ingredients and ratio of ingredients for a BBQ sauce in accordance with a preferred embodiment of the present invention; and

FIG. 2 is a flow chart depicting the preferred steps to create the BBQ sauce described in FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a recipe for a unique BBQ sauce and method of making the same.

As described above, BBQ sauce is a flavorful condiment typically used in grilling and barbecuing to enhance the taste of meats like ribs, chicken, and burgers. It varies widely in flavor, texture, and ingredients, but generally features a balance of sweet, tangy, smoky, and sometimes spicy notes.

BBQ sauce typically comes in many regional variations, including:

Kansas City style is often thick, sweet, and tangy, with a molasses or brown sugar base.

Memphis style tends to be more vinegar-based, with a tangy and peppery profile.

Carolina styles (especially in the Eastern and Lexington regions) are vinegar-forward, sometimes with a hint of mustard.

Texas-style BBQ sauce is typically spicier and has a more pronounced tomato base.

BBQ sauce can be used as a marinade, a dipping sauce, or brushed onto grilled meats during cooking to create a flavorful glaze.

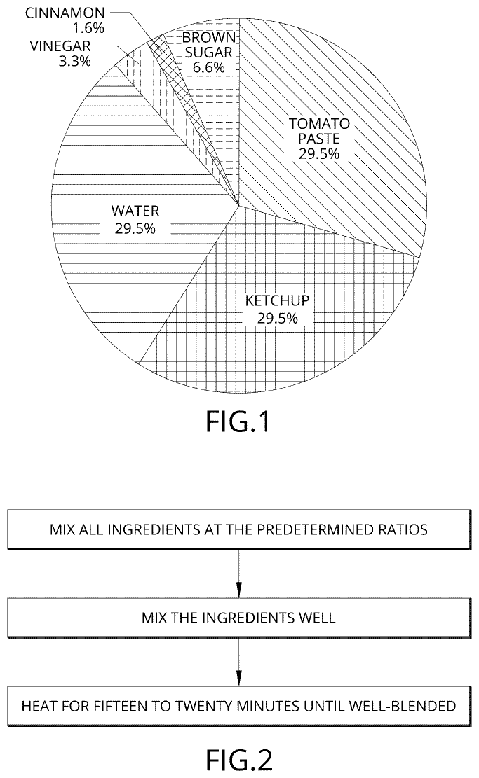

The BBQ sauce of the present invention, (THE ORIGINAL SKEET'S BAR-B-QUE SAUCE OF OMAHA, NEBRASKA), comprises a unique combination of tomato paste, ketchup, water, vinegar, cinnamon and brown sugar. As seen in FIG. 1, and as described herein, in a preferred embodiment the BBQ sauce of the present invention comprises approximately:
36 ounces of tomato paste;
36 ounces of ketchup;
36 ounces of water;
4 ounces of vinegar;
2 ounces of cinnamon; and
8 ounces of brown sugar.

Of course, the specific amounts of the above listed ingredients can be varied as a matter of application specific design choice so long as the ratio of the ingredients remains essentially the same.

As seen in FIG. 2, in a preferred embodiment a method for making the BBQ sauce of the present invention, (THE ORIGINAL SKEET'S BAR-B-QUE SAUCE OF OMAHA, NEBRASKA), comprises (1) mixing all the ingredients at the listed ratios, (2) mixing well, and (3) heating the resulting mixture to a slow boil and stirring the mixture for 15 to 20 minutes until well blended. The resulting sauce should then be allowed to cool before applying to the food of choice. The resulting BBQ sauce is nutritious and fulfilling and provides sustenance.

It should be understood, of course, that the foregoing relates to exemplary embodiments of the invention and that modifications may be made without departing from the spirit and scope of the invention as set forth in the following claims.

What is claimed is:

1. A BBQ sauce comprising approximately:
29.5% tomato paste;
29.5% ketchup;
29.5% water;
3.3% vinegar;
1.6% cinnamon; and
6.6% brown sugar.

2. A sauce for food, said sauce comprising, approximately:
36 parts of tomato paste;
36 parts of ketchup;
36 part of water;
4 parts of vinegar;
2 parts of cinnamon; and
8 parts of brown sugar.

3. A method of making a sauce for food, the sauce comprising approximately 36 parts of tomato paste, 36 parts of ketchup, 36 parts of water, 4 parts of vinegar, 2 parts of cinnamon, and 8 parts of brown sugar;
the method comprising:
mixing all the sauce ingredients at the listed ratios;
heating the resulting mixture to a slow boil; and
stirring the mixture for 15 to 20 minutes until well blended.
